(19) United States
(12) Patent Application Publication
(10) Pub. No.: US 2009/0086023 A1
(43) Pub. Date: Apr. 2, 2009

(54) SENSOR SYSTEM INCLUDING A CONFIGURATION OF THE SENSOR AS A VIRTUAL SENSOR DEVICE

(76) Inventor: David L. McCubbrey, Ann Arbor, MI (US)

Correspondence Address: SCHOX PLC, 730 Florida Street #2, San Francisco, CA, 94110, US

(21) Appl. No.: 12/175,821

(22) Filed: Jul. 18, 2008

Related U.S. Application Data
(60) Provisional application No. 60/950,547, filed on Jul. 18, 2007.

(51) Int. Cl. H04N 7/18

(52) U.S. Cl. 348/143; 348/E05.022

(57) ABSTRACT

The sensor system of the preferred embodiment includes a sensor, a sensor configuration ROM adapted to store a sensor description including a root directory, a unit directory, a first dependent unit directory to configure the sensor as a first virtual sensor device, a second dependent unit directory to configure the sensor as a second virtual sensor device, and a software driver adapted to interface with the first virtual sensor device and the second virtual sensor device. The sensor system of the preferred embodiments extends the conventional IIDC camera software model to include the concept of multiple sensor/camera units that reside within a single node on an IEEE 1394 bus.

### CROSS-REFERENCE TO RELATED APPLICATIONS

This application claims the benefit of U.S. Provisional Application No. 60/950,547, filed 18 Jul. 2007, which is incorporated in its entirety by this reference.

### TECHNICAL FIELD

This invention relates generally to the surveillance field, and more specifically to a new and useful sensor system in the surveillance field.

### BACKGROUND

The IIDC is the Digital Camera Sub-Working Group (DC-SWG) of the Instrumentation and Industrial Control Working Group (II-WG) of the 1394 Trade Association. The IIDC standard defines an abstract set of digital camera functions and controls that map onto IEEE 1394 to allow operation of IEEE 1394 cameras from different manufacturers from a single software device driver. In some surveillance situations, it is advantageous to provide more than one image stream from a single device. All current IIDC device driver implementations assume, however, only one image stream is possible from a single camera. In fact, the IEEE 1394 standard defines the concepts of device nodes and device units in an abstract fashion without regard to how they might apply to support multiple data streams from a single device node. Standard IIDC device drivers are unable to recognize and control more than a single image stream from a single device. Thus, there is a need in the surveillance field to create a new and useful camera system. This invention provides such a new and useful system and method.

### BRIEF DESCRIPTION OF THE FIGURES

FIG. 1 is a schematic representation of the first preferred embodiment of the invention.

FIG. 2 is an example of a modified configuration ROM for the multi-unit implementation.

FIG. 3 is a flowchart representation of a preferred method of the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention. In this document, the IEEE Standard for a High Performance Serial Bus, more specifically standards 1394-1995, 1394a-2000, and 1394b-2002 are collectively referred to as IEEE 1394.

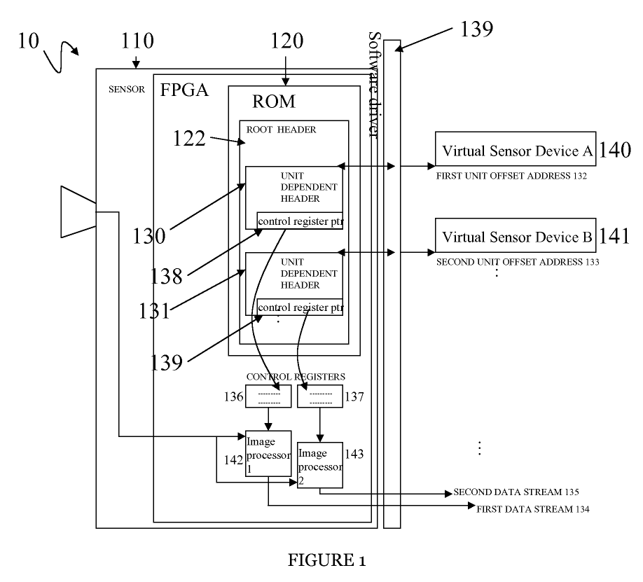

As shown in FIG. 1, a sensor system 10 of the preferred embodiments includes a sensor 110; a sensor configuration ROM 120 adapted to store remotely readable information about the sensor, including a root directory 122, a first unit dependent directory 130 to configure the sensor 110 as a first virtual sensor device 140, a second unit dependent directory 131 to configure the sensor 110 as a second virtual sensor device 141; and a software driver 145 adapted to interface with the first virtual sensor device 140 and the second virtual sensor device 141. The system of the preferred embodiments advertises multiple virtual sensor devices instead of a single sensor device, which allows multiple simultaneous readouts from a single sensor, such as a single camera. The method of the preferred embodiments extends the conventional IIDC camera software model to include the concept of multiple sensor/camera units that reside within a single node on an IEEE 1394 bus. Since the system and method are preferably implemented to be IIDC compliant and to not require higher-level adjustments to the IIDC model itself, the system and method enable an easy transition of existing software frameworks with single-stream camera readouts to multiple image streams from a single camera source.

The sensor 110 of the preferred embodiments functions to capture sensor data. Sensor data preferably includes image, video and/or audio data, but may alternatively capture infra-red images, vibration data, ultrasound data, chemical data, radioactivity data, light data, pressure data, temperature data, humidity data, smoke data, or any other suitable data. The sensor 110 is preferably a camera and, more preferably, a digital video camera. The sensor 110 may alternatively be a digital camera, an analog video camera, forward looking infra-red camera, an infrared-camera, microphone, vibration sensor, ultrasound sensor, chemical sensor, radioactive sensor, light sensor, pressure sensor, temperature sensor, humidity sensor, smoke sensor, or any other suitable sensor device. The sensor 110 preferably includes at least one output channel for sensor data. The output channel is preferably a data bus compatible with IEEE 1394, but may alternatively be compatible with PCI express, PCI, ISA, USB, Ethernet, wireless, or any other suitable communication interface.

The sensor configuration ROM 120 of the preferred embodiment functions to interface with the software driver to describe at least one sensor configuration, and instruct the software driver on the potential capabilities of the sensor 110 upon initialization or reconfiguration of the sensor 110 (e.g. at power on or operational mode switching). The sensor configuration ROM 120 is preferably stored within an FPGA, but may alternatively be stored within a programmable processor, an EEPROM, a flash memory device, or any other suitable memory storage device. The sensor configuration ROM 120 preferably provides pointers 132 and 133 to addresses within a 1394 CSR memory space. The sensor configuration ROM 120 may be re-programmable. In one variation, the sensor configuration ROM 120 may be reconfigured via a programmable processor connected to the sensor configuration ROM 120.

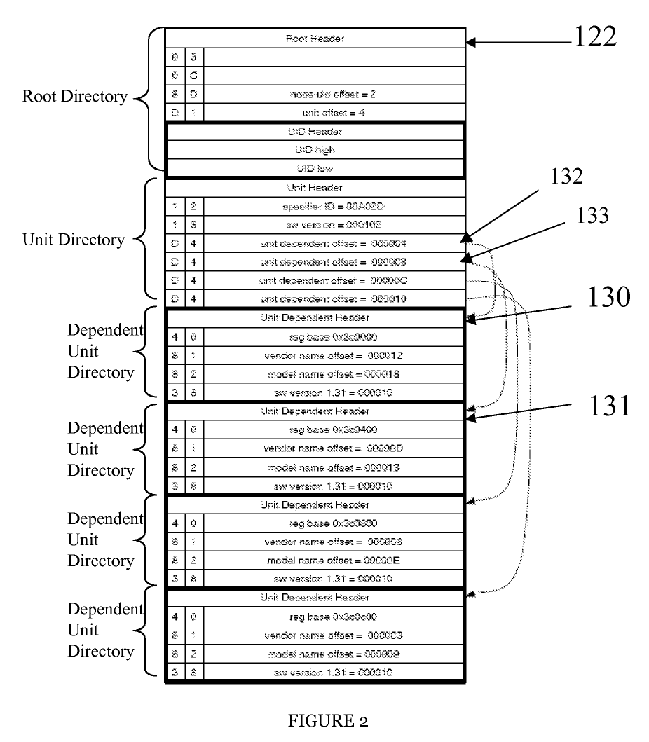

The root directory 122 of the sensor configuration ROM 120 functions to generally describe capabilities of the sensor 110, to describe multiple dependent unit configurations 130 and 131, and to interface with the software driver 145. The root directory 122 is preferably stored in the sensor configuration ROM 120. The root directory 122 preferably includes a plurality of dependent unit directories 130 and 131. The root directory 122 preferably includes 4-64 dependent unit directories 130 and 131, but may include any suitable number of dependent unit directories. As exemplified in FIG. 2, the preferred root directory 122 is preferably an IEEE 1394 configuration, including a Root Header with node and unit offsets, UID, specifier ID, and SW version, and unit dependent header offsets.

The dependent unit directories 130 and 131 of the sensor configuration ROM 120 function to allow software to configure the sensor as a plurality of virtual sensor devices 140 and 141. Each dependent unit directory 130 and 131 preferably includes pointers 138 and 139 to individual sets of device control registers 136 and 137. The device control register pointers 138 and 139 are preferably located at a unit dependent offset referenced in the unit directory 122, but may alternatively be located at any suitable offset. The dependent unit device control registers 136 and 137 also preferably configure a separate data stream output channel for each virtual sensor device 134 and 135, and sets a data rate for the virtual sensor device 140 and 141. As shown in FIG. 2, the dependent unit directories 130 and 131 are preferably addressable dependent unit directories located at a dependent unit offset. While only two dependent unit directories 130 and 131 are labeled, four dependent unit directories are exemplified in FIG. 2. The dependent unit directories 130 and 131 is preferably IEEE 1394 dependent unit directories, preferably including a register block base address, a vendor name offset, model name offset, software version, and control register blocks 136 and 137 (preferably IIDC compliant control registers).

The virtual sensor devices 140 and 141 function to provide a virtual sensor interface for an external software program or higher-level software such as operating system. The virtual sensor device preferably appears as an IEEE 1394 connected device to an operating system, and multiple virtual sensor devices 140 and 141 may be recognized by an operating system, depending on the number of dependent units that define virtual sensor devices 140 and 141 and the interaction of the virtual sensor devices 140 and 141 with the software driver 145. The virtual sensor device 140 and 141 is preferably controlled via a set of control register blocks 136 and 137 located at a register base referenced by a register base address pointer 138 and 139 in the unit directories 130 and 131. Multiple virtual sensor devices 140 and 141 are preferably simultaneously accessible.

The software driver 145 of the preferred embodiments functions to adapt higher level software to interface with the sensor configuration ROM 120, the sensor root directory 122, the dependent unit directories 130 and 131, and the sensor 110 via the independent control register blocks 136 and 137, and to define virtual sensor devices 140 and 141. The software driver 145 is preferably adapted to associate a first set of control registers 136 with the first virtual sensor device 140 that outputs a first data stream 134, and to associate the second set of control registers 137 with a second virtual sensor device 141 that outputs a second data stream 135. Preferably, as the software driver 145 communicates with external software (e.g. device discovery software in an operating system), the software driver 145 interfaces with an array of unit offset address pointers available to higher-level software instead of a single address pointer. The array of unit pointers is preferably displayed as an array of virtual sensor devices 140 and 141, but may alternatively be an array of unit offset addresses directly accessible by an external software program or operating system. In one variation, the software driver 145 functions to re-configure the virtual sensor devices 140 and 141 based upon external software limitations (e.g. adjusting a video bitrate to the maximum bitrate supported by the external software).

The unit offset address pointers 132 and 133 function to point to an offset address of a dependent unit directory 130 and 131 including pointers 138 and 139 to a set of control registers 136 and 137. The unit offset address pointer is preferably included in the root directory 122, but may alternatively be located in a lookup table anywhere in the address space of the sensor configuration ROM 120. The unit offset address pointers 132 and 133 are preferably static address pointers, but may alternatively be dynamically allocated pointers (i.e. in the variation including a dynamic number of dependent configurations).

The set of control registers, 136 and 137 function to provide low level control and configuration for the IEEE 1394 communications and sensor hardware. The set of control registers are preferably compliant with IIDC standards. The control registers 136 and 137 are preferably accessible only to the software driver 145, but may alternatively be directly accessible by external software and/or operating system software. The control registers are each preferably configured by writing a value to a 1394 CSR control register address. The control registers 136 and 137 preferably allow the control of at least one sensor data capture property such as resolution and/or frequency of still image capture, framerate of video capture, resolution of video capture, bitrate of video capture, multi-resolution video capture, or specific color components to capture, or any other suitable sensor data capture property. In addition, the control registers 136 and 137 may control processing of the sensor data to enhance contrast, balance color, or detect motion or any other suitable sensor data processing property. The pointer to the control registers 138 and 139 function to point to a base address of a set of control registers 136 and 137. These pointers are preferably included in a dependent unit directory 130 and 131.

In one alternative embodiment, the system further includes a processor 142 and 143 which functions to process the sensor data output into a data stream 134 and 135 to output for a virtual sensor device. The processor may be configured by the sensor configuration to select and or control properties of the output on the data channels. The processor may be configured to process the sensor data to capture still images, to capture video at a specific framerate, to capture video at a specific resolution, to capture video at a specific bitrate, to capture multi-resolution video (as taught in U.S. patent application Ser. No. 11/891,516), or to capture specific color components. Specific color components may include, for example, Red of Red-Green-Blue (RGB), infrared (IR), or any other suitable color components. The processor 142 and 143 may be controlled by the control registers. Each data stream 134 and 135 is preferably simultaneously accessible. In a first example, a first video captured and processed by a first processor 142 and output at a lower framerate with a lower resolution may be transmitted to an overview video screen, and a second video captured and processed by a second processor 143 and output at a higher framerate with a higher resolution from the same video camera 110 may be transmitted to a second video screen for a simultaneous detailed view. In a second example, the Red, Green and Blue channels may be transmitted separately and simultaneously digitally processed (e.g. equalization, filtering) by the processors 142 and 143 to enhance the colorization of a video.

In the same alternative embodiment, the data stream output 134 and 135 from each dependent unit data stream channel is preferably a stream of processed sensor data (from the processor 142 and 143) output through a virtual sensor device. The data stream channel is preferably handled by the software driver 145 and passed into a higher level software program or lower level FPGA for further processing. In a first alternative embodiment, the data stream output 134 and 135 may be an audio channel. The audio channel may be a separate audio channel captured from an audio/video camera, or may be a separate audio channel separated from multiple combined audio channels using a processor 142 and 143 performing independent component analysis.

In one alternative embodiment, the sensor 110 may be a microphone and the dependent unit control registers 136 may control a programmable processor 142 and 143 adapted to separate simultaneous audio data streams using independent component analysis. The separated audio data streams may be recognized by a software driver as a first microphone data stream and a second microphone data stream, to enable a higher level software to recognize the independent audio channels as the output of independent devices. The programmable processor may be included on an FPGA, or may be a microcontroller connected to the sensor 110.

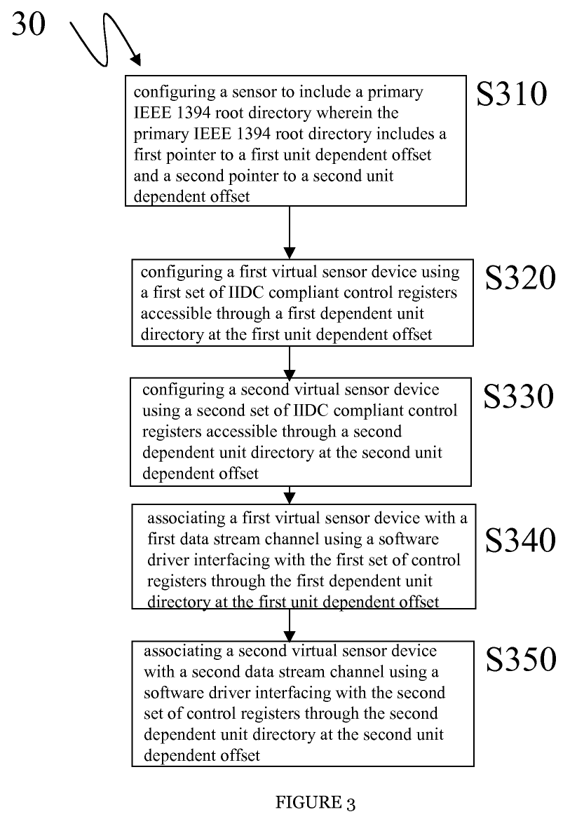

As shown in FIG. 3, a method 30 of addressing multiple data streams from a single sensor device includes configuring a sensor to include a primary IEEE 1394 root directory wherein the primary IEEE 1394 root directory includes a first pointer to a first unit dependent offset and a second pointer to a second unit dependent offset S310, configuring a first virtual sensor device using a first set of IIDC compliant control registers accessible through a first dependent unit directory at the first unit dependent offset S320, configuring a second virtual sensor device using a second set of IIDC compliant control registers accessible through a second dependent unit directory at the second unit dependent offset S330, associating a first virtual sensor device with a first data stream channel using a software driver interfacing with the first set of control registers through the first dependent unit directory at the first unit dependent offset S340, and associating a second virtual sensor device with a second data stream channel using a software driver interfacing with the second set of control registers through the second dependent unit directory at the second unit dependent offset S350.

Step S310 recites configuring a sensor to include a primary IEEE 1394 root directory wherein the primary IEEE 1394 root directory includes a first pointer to a first unit dependent offset and a second pointer to a second unit dependent offset. The primary IEEE 1394 configuration preferably includes a Root Header with node and unit offsets, UID, specifier ID, and SW version, and unit dependent header offsets. Step S310 preferably includes allocating unit dependent offsets for a fixed plurality (preferably 4-64) of unit dependent configurations, but may alternatively include dynamically allocating unit dependent configurations. Step S310 is preferably performed once at an initial configuration, but may alternatively include reconfiguration and reprogramming under certain conditions such as mode switching, or a power reset.

Step S320 recites configuring a first virtual sensor device using a first set of IIDC compliant control registers accessible through a first dependent unit directory at the first unit dependent offset. The virtual sensor configuration is preferably performed in a higher level operating system, but may alternatively be performed in a lower level operating system, or may be set to a fixed factory setting. The IIDC compliant control registers enable standard functionality for configuring the sensor, and the complete virtual sensor configuration also preferably includes an IEEE 1394 unit dependent directory. Step S320 preferably includes accessing the IEEE 1394 unit dependent directory at a unit dependent offset, and may include accessing the IIDC compliant control registers using a pointer to the IIDC compliant control registers. Step S320 preferably includes configuring at least one sensor data capture property such as resolution and/or frequency of still image capture, framerate of video capture, resolution of video capture, bitrate of video capture, multi-resolution video capture, or specific color components to capture.

Step S330 recites configuring a second virtual sensor device using a second set of IIDC compliant control registers accessible through a second dependent unit directory at the second unit dependent offset. Except for the use of the second virtual sensor device using a second set of IIDC compliant control registers accessible through a second dependent unit directory at a second unit dependent offset, Step S330 is preferably identical to Step S320.

Step S340 recites associating a first virtual sensor device with a first data stream channel using a software driver interfacing with the first set of control registers through the first dependent unit directory at the first unit dependent offset. Step S340 preferably includes recognizing a first virtual sensor device at an address (the unit dependent offset or alternatively the address of the pointer to the IIDC compliant control registers), defining the properties of the data channel, and displaying the properties (e.g. name, address, bitrate) of the virtual sensor device to external software upon request. Step S340 may include configuring or re-configuring the virtual sensor device based upon external software limitations (e.g. adjusting a video bitrate to the maximum bitrate supported by the external software). In one variation, Step S340 may include separating individual sensor data components to associate with the first virtual sensor device, such as audio channels (e.g. L and R), color components (e.g. RGB), or mixed audio signals using independent component analysis.

Step S350 recites associating a second virtual sensor device with a second data stream channel using a software driver interfacing with the second set of control registers through the second dependent unit directory at the second unit dependent offset. Except for the use of the second virtual sensor device using a second set of control registers through the second dependent unit directory at a second unit dependent offset, Step S350 is preferably identical to Step S340.

As a person skilled in the art will recognize from the previous detailed description and from the figures and claims, modifications and changes can be made to the preferred embodiments of the invention without departing from the scope of this invention defined in the following claims.

I claim:

1. A sensor system, comprising:
a sensor;
a sensor configuration ROM adapted to store a sensor description including a root directory, wherein the root directory includes:
a unit directory;
a first dependent unit directory to configure the sensor as a first virtual sensor device;
a second dependent unit directory to configure the sensor as a second virtual sensor device; and
a software driver adapted to interface with the first virtual sensor device and the second virtual sensor device.

2. The sensor system of claim 1, wherein the first virtual sensor device and the second virtual sensor device are simultaneously accessible.

3. The sensor system of claim 2, wherein the software driver associates a first data stream channel with the first virtual sensor device, and wherein the software driver associates a second data stream channel with the second virtual sensor device.

4. The sensor system of claim 3, wherein the unit directory includes a first pointer to a first unit dependent offset, and a second pointer to a second unit dependent offset.

5. The sensor system of claim 4, wherein the first dependent unit directory includes a pointer to a first set of control registers for the first virtual sensor device at the first unit dependent offset, and wherein the second dependent unit directory includes a pointer to a second set of control registers for the second virtual sensor device at the second unit dependent offset.

6. The sensor system of claim 5, wherein the software driver interfaces with the first virtual sensor device using the first set of control registers at the first unit dependent offset, and wherein the software driver interfaces with the second virtual sensor device using the second set of control registers at the second unit dependent offset.

7. The sensor system of claim 5, wherein the control registers are compliant with the IIDC standard.

8. The sensor system of claim 3, further comprising a processor adapted to output sensor data to the first data stream channel and the second data stream channel, wherein the processor outputs an image capture of a first plurality of pixels within the sensor field of view on the first data stream channel, and wherein the processor outputs an image capture of a second plurality of pixels within the sensor field of view on the second data stream channel.

9. The sensor system of claim 8, wherein the second plurality of pixels is a subset of the first plurality of pixels.

10. The sensor system of claim 8, wherein the second plurality of pixels is a derivative of the first plurality of pixels that encodes image content information.

11. The sensor system of claim 8, wherein the processor outputs an image capture of a first color component on the first data stream channel, and the processor outputs an image capture of a second color component on the second data stream channel.

12. The sensor system of claim 8, wherein the processor outputs a first video captured at a first bitrate on the first data stream channel, and the processor outputs a second video captured at a second bitrate on the second data stream channel.

13. The sensor system of claim 12, wherein the first video is captured at a first framerate, and a second video is captured at a second framerate.

14. The sensor system of claim 12, wherein the first video is captured at a first resolution and a second video is captured at a second resolution.

15. The sensor system of claim 1, wherein the sensor is a microphone.

16. The sensor system of claim 15, further comprising a processor adapted to separate a first audio data stream and a second audio data stream using independent component analysis, and wherein the first audio data stream is associated with the first virtual sensor device and the second audio data stream is associated with the second virtual sensor device.

17. The sensor system of claim 1, wherein the root directory is an IEEE 1394 configuration ROM root directory.

18. The sensor system of claim 17, wherein the first dependent unit directory and the second dependent unit directory are IEEE 1394 device unit dependent directories within the IEEE 1394 configuration ROM root directory.

19. The sensor system of claim 1, wherein the sensor is a camera and the camera is one selected from the group consisting of analog camera, digital camera, analog video camera, digital video camera, forward looking infra-red camera, and infra-red camera.

20. A camera system, comprising:
a camera;
a camera configuration ROM, adapted to store an IEEE 1394 device description including:
an IEEE 1394 configuration ROM root directory including a first pointer to a first unit dependent offset, and a second pointer to a second unit dependent offset;
a first IEEE 1394 unit dependent configuration to configure the camera as a first virtual camera device using a first set of IIDC compliant control registers accessible at the first unit dependent offset;
a second IEEE 1394 unit dependent configuration to configure the camera as a second virtual camera device using a second set of IIDC compliant control registers accessible at the second unit dependent offset; and
a software driver adapted to interface with the first virtual camera device using the first set of control registers at the first unit dependent offset and to interface with the second virtual camera device using the second set of control registers at the second unit dependent offset, and wherein the software driver associates a first data stream channel with the first virtual camera device and wherein the software driver associates a second data stream channel with the second virtual camera device.

21. A method of addressing multiple data streams from a single sensor device comprising:
configuring a sensor to include an IEEE 1394 root directory wherein the primary IEEE 1394 root directory includes a first pointer to a first unit dependent offset and a second pointer to a second unit dependent offset;
configuring a first virtual sensor device using a first set of IIDC compliant control registers accessible through a first dependent unit directory at the first unit dependent offset;
configuring a second virtual sensor device using a second set of IIDC compliant control registers accessible through a second dependent unit directory at the second unit dependent offset;
associating a first virtual sensor device with a first data stream channel using a software driver interfacing with the first set of control registers through the first dependent unit directory at the first unit dependent offset; and
associating a second virtual sensor device with a second data stream channel using a software driver interfacing with the second set of control registers through the second dependent unit directory at the second unit dependent offset.
